(19) United States
(12) Patent Application Publication
(10) Pub. No.: US 2005/0190304 A1
(43) Pub. Date: Sep. 1, 2005

(54) Radio frequency (RF) modulator with narrow bandpass filter

(76) Inventors: Jong Gi Ryu, Yongin (KR); Duck Whan Kim, Suwon (KR); Dong Taek Moon, Suwon (KR); Dae Yoo Lee, Suwon (KR); Kyu-O Jeon, Suwon (KR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/834,177

(22) Filed: Apr. 29, 2004

(30) Foreign Application Priority Data
Feb. 27, 2004 (KR) 2004-13478

(51) Int. Cl. H04N 5/40; H04N 7/04

(52) U.S. Cl. 348/724; 348/470

(57) ABSTRACT

Disclosed herein is RF modulator with a narrow bandpass filter. The RF modulator for modulating video and audio signals into RF signals corresponding to a frequency band of a predetermined channel includes an oscillation unit for generating a predetermined RF signal suitable for the frequency band of the predetermined channel; a mixer for modulating the video and audio signals using the RF signal generated from the oscillation unit; and a narrow bandpass filter for receiving an RF-modulated signal from the mixer, and passing only a signal of the frequency band of the predetermined channel from among the RF-modulated signal. Therefore, the RF modulator can remove or block unnecessary components such as lower side band and harmonic-frequency signals generated after video and audio signals have been RF-modulated, such that it can prevent interference between channels from being generated, resulting in the creation of more excellent video and audio signals.

### BACKGROUND OF THE INVENTION

1. Field of the Invention

The present invention relates to an RF (Radio Frequency) modulator for modulating video and audio signals into an RF broadcast signal of a predetermined channel, and more particularly to an RF modulator which can remove unnecessary signals such as harmonic-frequency signals generated from a lower sideband of a modulated broadcast signal and a frequency band of other channels using a narrow bandpass filter.

2. Description of the Related Art

Typically, an RF modulator has been adapted to a variety of television (TV) connection devices for generating video and audio signals using a TV, for example, cable TV receivers and satellite broadcast receivers, such that it converts input video and audio signals into RF signals of a selected channel according to a TV broadcast scheme and generates the RF signals.

FIG. 1 is a block diagram illustrating a conventional RF modulator. Referring to FIG. 1, the RF modulator distributes an RF broadcast signal received via an antenna to a distributor 23, such that the distributor 23 outputs the RF broadcast signal to a tuner output terminal TUNER OUT connected to a tuner and a TV output terminal TV OUT connected to a TV. In this case, a plurality of amplifiers 21 and 22 for amplifying reception signals may also be connected to the front and rear sides of the distributor 23.

The video clamp 111 receives a baseband video signal from a video signal input terminal VIDEO IN, performs a level variation of the baseband video signal within a predetermined variation range, and outputs the resultant signal to the clipper circuit 112. The clipper circuit 112 receives the output signal from the video clamp 111, removes noise from the received signal, and outputs the resultant signal to the AM (Amplitude Modulation) modulator 113. The AM modulator 113 receives the output signal from the clipper circuit 112, and modulates the received signal into an IF (Intermediate Frequency)—band signal. The pre-emphasis circuit 121 receives an audio signal from an audio signal input terminal AUDIO IN, compresses the received audio signal, and outputs the compressed result signal to the audio amplifier 122. The audio amplifier 122 receives the output signal from the pre-emphasis circuit 121, amplifies the received signal, and outputs the amplified result signal to the FM (Frequency Modulation) modulator 123. The FM modulator 123 receives the output signal from the audio amplifier 122, and modulates the received signal into an IF-band signal in such a way that it can perform an FM modulation of the received signal. The video/audio signals modulated into the IF-band signals are transmitted to the mixer 15 over the buffer 13. The mixer 15 loads the video/audio signals on predetermined channel RF signals generated from the oscillation unit 14, and generates the video/audio signals having the predetermined channel RF signals in such a way that it generates RF modulation signals.

The RF-modulated audio/video signals are transmitted to a broadband LPF (Low Pass Filter) 16, such that the broadband LPF 16 filters an RF signal of a desired frequency from among the received RF-modulated audio/video signals, and outputs the filtered result signal to the TV via a TV output terminal TV OUT. In this case, it should be noted that the output signal of the broadband LPF 16 passes through the high pass filter (HPF) 24 before the TV output terminal TV OUT receives such RF signals.

FIG. 2 is an exemplary graph illustrating a frequency component of the RF-modulated signal generated from the mixer 15 contained in the conventional RF modulator of FIG. 1. In more detail, FIG. 2 is an exemplary signal available for an NTSC (National Television System Committee)—based TV set. A predetermined frequency band of 6 MHz is assigned to each channel of the TV. The signal 30 desired to be generated from a predetermined channel includes a picture signal (also called a luminance signal) P for expressing an image signal in the form of a difference between black-and-white luminances, a color difference signal (also called a chrominance signal) C for expressing a color tone, and an audio signal S.

However, an oscillation frequency f_{osc} transmitted from the oscillation unit 14 to the mixer 15 of FIG. 1 to carry out an RF modulation function is equal to a frequency of the picture signal P, such that symmetrical chrominance signals C and symmetrical audio signals S are generated at both ends of the picture signal P. The oscillation frequency f_{osc} is spaced apart from a frequency at which a corresponding channel begins by a predetermined value of 1.25 MHz. The chrominance and audio signals F2 generated prior to the picture signal P occur in a frequency band assigned to another channel. Not only picture, chrominance and audio signals F1 generated in a frequency band of a desired channel, but also unnecessary chrominance and audio signals F2 are generated in a frequency band of a previous channel. In this way, a signal generated in a low frequency band from among a plurality of signals symmetrically generated at an overall frequency band is called a lower sideband signal.

Due to several negative characteristics of the modulator circuit (particularly, the amplifier), harmonic-frequency signals C1˜C3 caused by spurious oscillation are generated in a frequency band of another channel.

In this way, due to the aforementioned unnecessary signals, such as the lower sideband and harmonic-frequency signals generated in the frequency band of another channel, interference unavoidably occurs in a signal broadcast to another channel.

To solve the aforementioned problems, the conventional RF modulator device controls an RF modulation signal to pass through the broadband LPF 16 of FIG. 1. However, provided that the RF modulation signal in which the lower sideband and harmonic-frequency signals shown in FIG. 2 are generated pass through the broadband LPF 16 of FIG. 1, the conventional RF modulator device can remove the harmonic-frequency signals generated in a channel adapting a frequency band higher than that of a desired channel, but it cannot effectively remove the lower sideband and harmonic-frequency signals generated in the other channel adapting a lower frequency band, such that such interference remains in other channels.

In conclusion, there must be newly developed an improved RF modulator which can remove unnecessary signals such as lower sideband and harmonic-frequency signals causing the interference phenomenon in other channels, and thereby generates only frequency band signals of a desired channel during the RF modulation time.

### SUMMARY OF THE INVENTION

Therefore, the present invention has been made in view of the above problems, and it is an object of the invention to provide an RF modulator including a narrow bandpass filter, which can remove unnecessary signals such as lower sideband and harmonic-frequency signals generated in a frequency band other than a frequency band assigned to a desired channel over which video and audio signals will be transmitted, such that it can prevent interference from being generated in another channel signal.

In accordance with the present invention, these objects are accomplished by providing a Radio Frequency (RF) modulator for modulating video and audio signals into RF signals corresponding to a frequency band of a predetermined channel, comprising: an oscillation unit for generating a predetermined RF signal suitable for the frequency band of the predetermined channel; a mixer for modulating the video and audio signals using the RF signal generated from the oscillation unit; and a narrow bandpass filter for receiving an RF-modulated signal from the mixer, and passing only a signal of the frequency band of the predetermined channel among the RF-modulated signal.

Preferably, the oscillation unit may include: an oscillator for generating an oscillation signal of a predetermined frequency according to a control voltage; a divider for dividing a frequency generated from the oscillator at a predetermined rate; a phase detector for comparing a division signal generated from the divider with a phase of a predetermined frequency; and a charge pump for providing the oscillator with the control voltage adjusted by a phase difference received from the phase detector.

Preferably, the narrow bandpass filter may include a plurality of variable voltage capacitor diodes and a plurality of inductors which adapt the control voltage as a reverse bias voltage, such that a pass band of the narrow bandpass filter changes with a variation in oscillation frequency of the oscillator affected by the control voltage.

Preferably, the narrow bandpass filter may be either a dielectric filter having a fixed pass band or a SAW (Surface Acoustic Wave) filter.

### BRIEF DESCRIPTION OF THE DRAWINGS

The above objects, and other features and advantages of the present invention will become more apparent after reading the following detailed description when taken in conjunction with the drawings, in which:

FIG. 1 is a schematic view illustrating a conventional RF modulator;

FIG. 2 is an exemplary graph illustrating a frequency component of the RF-modulated signal generated from the conventional RF modulator of FIG. 1;

FIG. 3 is a block diagram illustrating an RF modulator including a narrow bandpass filter in accordance with a preferred embodiment of the present invention;

FIG. 4a is a block diagram illustrating an exemplary oscillator in accordance with a preferred embodiment of the present invention;

FIG. 4b is a schematic diagram illustrating an exemplary narrow bandpass filter in accordance with a preferred embodiment of the present invention;

FIGS. 4c and 4d are exemplary graphs illustrating frequency pass characteristics of the narrow bandpass filter in accordance with a preferred embodiment of the present invention;

FIG. 5a is a block diagram illustrating an oscillator, a mixer, and a bandpass filter in accordance with another preferred embodiment of the present invention; and

FIGS. 5b and 5c are exemplary graphs illustrating frequency pass characteristics of a SAW (Surface Acoustic Wave) filter in accordance with another preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

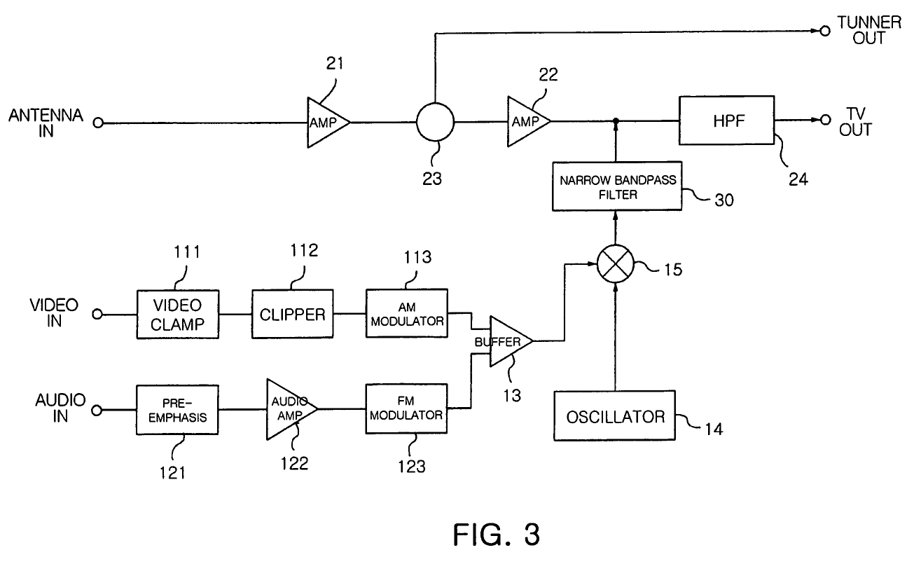

FIG. 3 is a block diagram illustrating an RF modulator including a narrow bandpass filter in accordance with a preferred embodiment of the present invention. The RF modulator includes a video clamp 111 for adjusting the level of a video signal received via a video input terminal VIDEO IN; a clipper 112 for removing out-of-band noise from a video signal received from the video clamp 111; an AM modulator for AM-modulating the video signal received from the clipper 112; a pre-emphasis module 121 for emphasizing a high-frequency band of the video signal received from an audio input terminal AUDIO IN using a predetermined time constant; an audio amplifier 122 for amplifying the audio signal generated from the pre-emphasis module 121 by a predetermined level; an FM modulator 123 for FM-modulating the audio signal generated from the audio amplifier 122; a buffer 13 for combining the video signal generated from the AM modulator 113 with the audio signal generated from the FM modulator 123; an oscillation unit 14 for generating a predetermined oscillation frequency corresponding to a desired channel over which the video and audio signals will be transmitted; a mixer 15 for loading the video and audio signals generated from the buffer 13 on an oscillation frequency generated from the oscillation unit 14, and generating the video and audio signals loaded on the oscillation frequency; and a narrow bandpass filter for filtering the video and audio signals generated from the mixer according to a frequency band of a desired channel over which the video/audio signals will be transmitted.

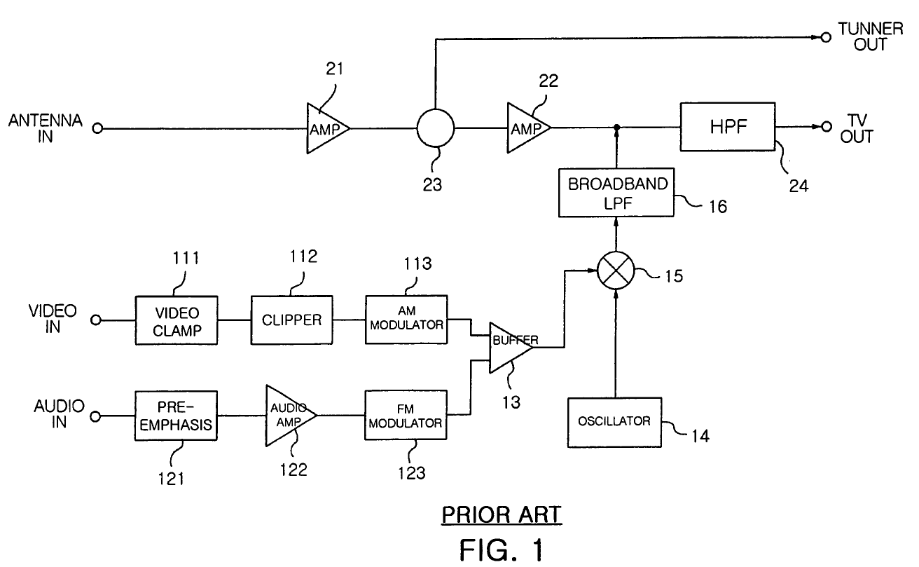

Particularly, the aforementioned RF modulator according to the present invention uses a narrow bandpass filter 30 for passing only frequency-band signals of a desired channel, instead of using the conventional broadband LPF 16 of FIG. 1.

The narrow bandpass filter 30 may use either a bandpass filter using a variable voltage capacitor (VVC) diode capable of automatically changing a pass band according to a frequency band of a used channel, or a fixed bandpass filter for passing a fixed frequency band. In accordance with the narrow bandpass filter including the variable voltage capacitor (VVC) diode, the oscillation unit 14 must generate an oscillation frequency using a PLL (Phase Locked Loop) scheme. In accordance with the narrow bandpass filter including the fixed bandpass filter, the oscillation unit 14 may use not only a PLL scheme but also a NON-PLL scheme (e.g., a NON-PLL scheme using a SAW-resonator) if needed.

A first preferred embodiment of the present invention in which the bandpass filter including the variable voltage capacitor (VVC) diode is employed will hereinafter be described.

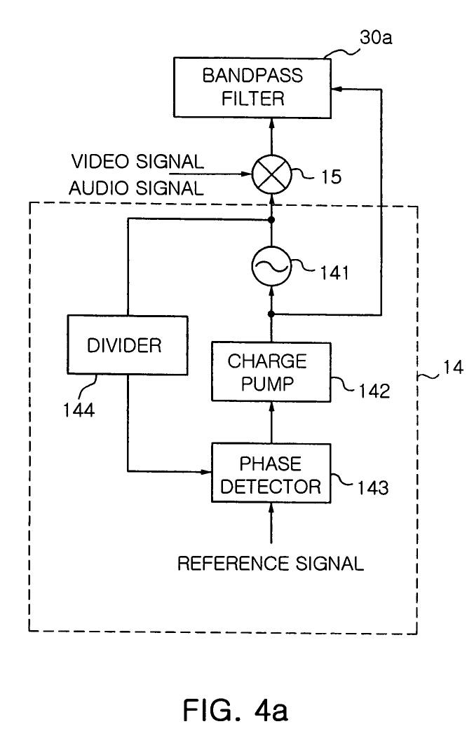

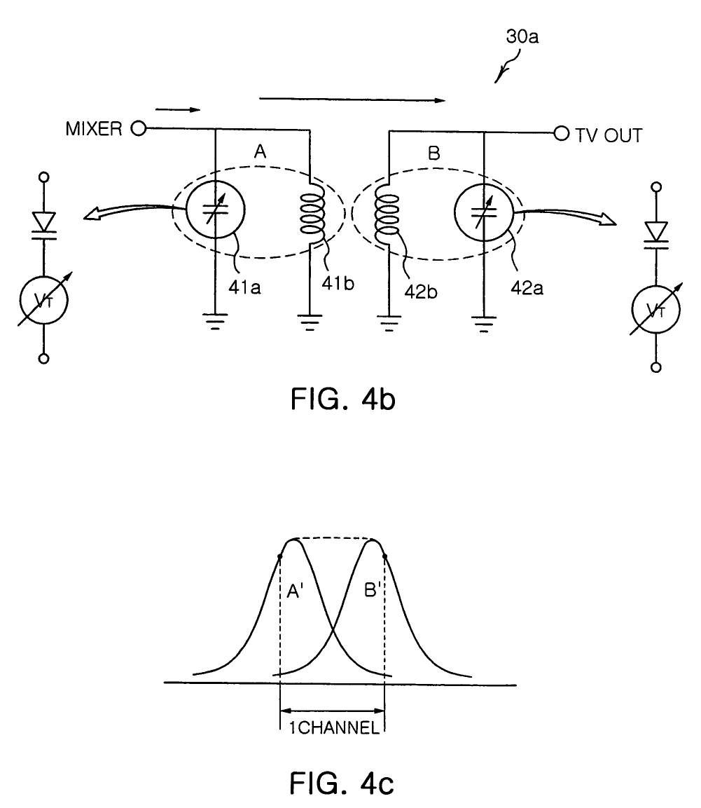

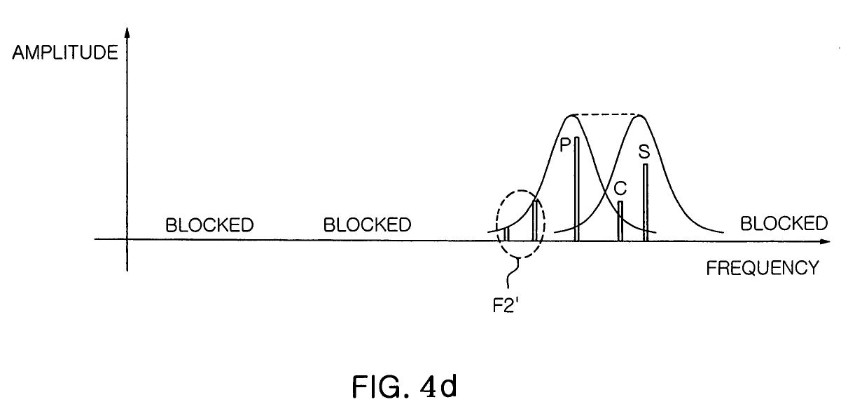

FIGS. 4a to 4d depict the first preferred embodiment adapting the bandpass filter including the variable voltage capacitor (VVC) diode according to the present invention.

FIG. 4a is a block diagram illustrating a PLL-based oscillation unit 14 for use in the first preferred embodiment of the present invention. Referring to FIG. 4a, the PLL-based oscillation unit 14 for use in the first preferred embodiment includes an oscillator 141 for generating an oscillation signal of a predetermined frequency according to a control voltage V_{T}; a divider 144 for dividing a frequency generated from the oscillator 141 at a predetermined rate; a phase detector 143 for comparing a division signal generated from the divider 144 with a phase of a predetermined frequency; and a charge pump 142 for providing the oscillator 141 with the control voltage adjusted by a phase difference received from the phase detector 143.

In the aforementioned PLL-based oscillation unit 14, the charge pump 142 provides the oscillator 141 with the control voltage V_{T}, the charge pump 142 transmits the control voltage V_{T} to the oscillator 141, and the oscillator 131 generates an oscillation signal of a predetermined frequency according to the control voltage V_{T}. Therefore, in order to control either the oscillator 141 or the PLL-based oscillation unit 14 to change the oscillation frequency, the control voltage V_{T} generated from the charge pump 142 must be changed to another voltage.

In more detail, in the case of changing a channel desired to output the video and audio signals to another channel, an oscillation frequency must be changed to another frequency, so that the control voltage V_{T} generated from the charge pump 142 must also be changed to another voltage. The present invention employs a bandpass filter 30a for changing a pass band to another pass band according to the control voltage V_{T} varying with the oscillation frequency of the PLL-based oscillation unit 14, such that it can control the bandpass filter 30a to pass only desired frequency band signals.

FIG. 4b is a schematic diagram illustrating a narrow bandpass filter 30a capable of varying a pass band according to the control voltage V_{T} in accordance with a preferred embodiment of the present invention. The narrow bandpass filter 30a may be comprised of two variable capacitors 41a and 42a and two inductors 41b and 42b. As can be seen from FIG. 4b, the variable capacitor is indicative of a variable voltage capacitor (VVC) diode for adapting the control voltage V_{T} used in the PLL-based oscillator as a reverse bias voltage.

The variable voltage capacitor (VVC) diode is also called a “Varicap”, and acts as an element for adapting a variation in PN-junction capacitance caused by the reverse bias voltage. If a PN junction diode is reverse-biased, the reverse bias voltage encounters a variation in a depletion layer, and the PN-junction capacitance varies with the variation in the depletion layer. In more detail, the wider the depletion layer (i.e., the higher the reverse bias voltage), the lower the PN-junction capacitance. The narrower the depletion layer (i.e., the lower the reverse bias voltage), the larger the PN-junction capacitance.

As can be seen from FIG. 4b, a variable voltage capacitor (VVC) diode 41a and an inductor 41b are connected in parallel between an output terminal of the mixer and a ground terminal, an inductor 42b and a variable voltage capacitor (VVC) diode 42a are connected in parallel between an output terminal TV OUT and a ground terminal in the form of a predetermined configuration symmetrical to the aforementioned VVC diode 41a and inductor 41b, resulting in a narrow bandpass filter capable of generating two resonance signals. In the case of properly selecting inductance values of the inductors and capacitance values of the variable voltage capacitor (VVC) diode 42a, a desired frequency band signal passes through the output terminal TV OUT over the mixer, and the remaining frequency band may also be blocked.

As stated above, a frequency characteristic generated by the aforementioned narrow bandpass filter is shown in FIG. 4c. Referring to FIG. 4c, a first resonance signal A′ is generated by the variable voltage capacitor (VVC) diode and inductor A connected between an input terminal for receiving a signal from the mixer and a ground terminal, and a second resonance signal B′ is generated by the variable voltage capacitor (VVC) diode and inductor B connected between an output terminal TV OUT and a ground terminal. Due to the aforementioned two resonance signals A′ and B′, a bandpass filter for passing predetermined frequency band signals shown in FIG. 4c can be implemented. Preferably, the present invention may adjust inductance values of the inductors and variable voltage capacitor diodes' capacitance values varying with a control voltage of a PLL structure, such that it may control a pass band of the bandpass filter to be equal to a frequency band assigned to a desired channel over which video and audio signals will be transmitted. For example, it is preferable that the pass band is determined to be a specific frequency band of 6 MHz assigned to one channel in case of using the NTSC scheme.

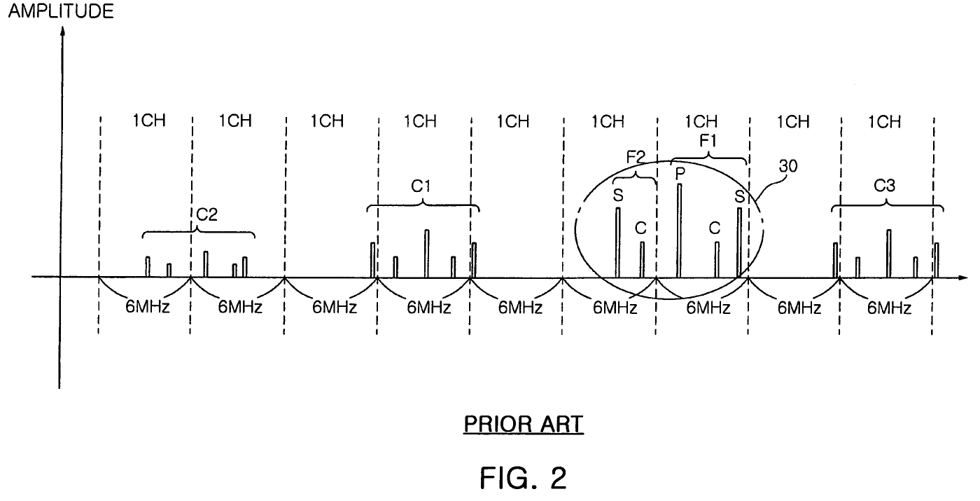

FIG. 4d depicts an example of a frequency component of an RF-modulated signal generated from the RF modulator including the narrow bandpass filter. In comparison with the aforementioned example of FIG. 2, it can be recognized that a picture signal P, a chrominance signal C, and an audio signal S associated with the output-desired channel are transmitted to a destination via a bandpass filter, and harmonic-frequency signals generated from other frequency bands of other channels are blocked. But, a lower sideband signal F2′ positioned in a frequency band of a nearby channel is not sufficiently removed because the filter composed of a capacitor and an inductor has poor skirt characteristics. Although a high-order filter may also be adapted to improve the skirt characteristics, a large number of components must be used, resulting in the unavailability of a small-sized and light-weight system.

A second preferred embodiment capable of sufficiently removing even lower sideband components from desired signals to improve the skirt characteristics will hereinafter be described.

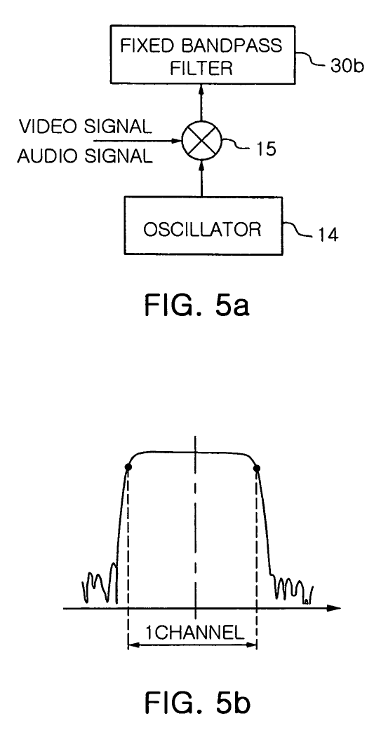

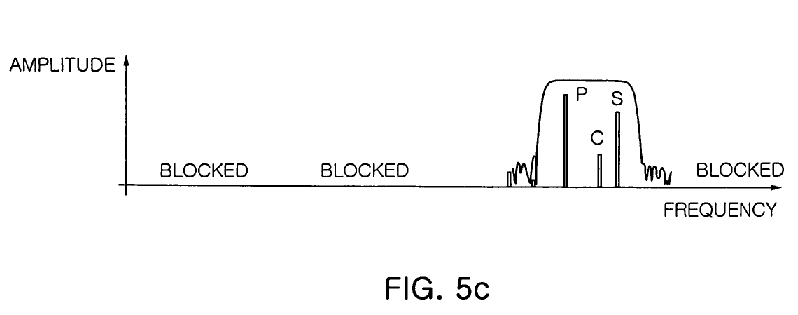

FIGS. 5a to 5c depict the second preferred embodiment for adapting a bandpass filter including a variable voltage capacitor (VVC) diode according to the present invention.

FIG. 5a is a block diagram illustrating an oscillation unit 14, a mixer 15, and a bandpass filter 30b in accordance with another preferred embodiment of the present invention.

The bandpass filter 30b for use in the second preferred embodiment of the present invention is either a dielectric filter or a fixed bandpass filter such as a SAW filter having a fixed pass band, such that it does not use a control voltage V_{T} for use in the PLL-based oscillator as in the aforementioned first preferred embodiment. Therefore, the oscillation unit 14 may use either a PLL-based oscillation unit as in the first preferred embodiment or a NON-PLL-based oscillation unit such as a SAW-resonator oscillator.

The fixed bandpass filter 30b may be equal to either a dielectric filter or a SAW filter.

The dielectric filter acts as a structure filter for adapting resonance caused by a wavelength, and reduces an electric wavelength of a signal using a dielectric ceramic of a high dielectric substance, such that it can implement a smaller-sized filter. A unit-wavelength resonator called a “Combline” is generally adapted as the dielectric filter, and the dielectric filter frequently uses a method for interconnecting different comblines one by one, and a mono-block method for enabling such different comblines to be implemented in the form of a single dielectric block. Also, a ceramic chip filter configured in a ceramic using a multilayer pattern may also be adapted as such dielectric filter.

The SAW (Surface Acoustic Wave) filter includes four comb-structured metal plates. The four comb-structured metal plates are arranged at a piezoelectric substrate, two comb-structured metal plates from among four comb-structured metal plates are arranged at one end of the piezoelectric substrate, and the remaining two comb-structured metal plates are arranged at the other end of the piezoelectric substrate, such that the four comb-structured metal plates are arranged at both ends of the piezoelectric substrate in an alternate manner. Upon receiving an electric signal from two metal plates arranged at one end of the piezoelectric substrate, a SAW signal is generated from the piezoelectric substrate. Mechanical vibration caused by the SAW signal is converted into electric signals at the other end of the piezoelectric substrate. In this case, if a frequency of the SAW signal generated from the piezoelectric substrate is different from that of the input electric signal, the SAW filter cannot transmit its reception signal to a destination. In other words, the SAW filter acts as a bandpass filter capable of passing only a frequency equal to a predetermined mechanical-substance frequency of the SAW filter. The SAW filter has a very narrow passable bandwidth as compared to a filter based on the artificial LC resonance principle, such that it can almost perfectly block unnecessary frequency signals. Further, the SAW filter has a smaller size than a dielectric filter having similar performances. To this end, it is most preferable for the SAW filter to be adapted to the present invention in order to allow only a frequency of a desired signal to correctly pass through a narrow bandwidth.

FIG. 5b is an exemplary graph illustrating a frequency pass characteristic. As can be seen from FIG. 5b, the present invention has very excellent skirt characteristics. For example, the NTSC-based TV may properly assign a SAW filter having a pass frequency bandwidth of 6 MHz to a frequency band of a corresponding channel, if needed.

FIG. 5c is an exemplary graph illustrating a frequency component of an RF-modulated signal generated from an RF modulator adapting the SAW filter. In comparison with the graph of FIG. 2, a picture signal P, a chrominance signal C, and an audio signal S of a corresponding frequency band associated with an output-desired channel are transmitted to a destination through the SAW filter, and harmonic-frequency signals generated from frequency bands of other channels are blocked, as can be seen from FIG. 5c. Particularly, differently from the first preferred embodiment, the second preferred embodiment can sufficiently remove even lower sideband components positioned in a frequency band of a nearby channel due to the excellent skirt characteristics of the SAW filter.

As stated above, the present invention includes a narrow bandpass filter for passing a frequency band of an output-desired channel, such that it blocks unnecessary components such as lower sideband and harmonic-frequency signals generated after video and audio signals have been RF-modulated, resulting in prevention of interference between channels.

As apparent from the above description, the present invention provides an RF modulator for removing or blocking unnecessary components such as lower side band and harmonic-frequency signals generated after video and audio signals have been RF-modulated, such that it can prevent interference between channels from being generated, resulting in the creation of excellent video and audio signals.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A Radio Frequency (RF) modulator for modulating video and audio signals into RF signals corresponding to a frequency band of a predetermined channel, comprising:
an oscillation unit for generating a predetermined RF signal suitable for the frequency band of the predetermined channel;
a mixer for modulating the video and audio signals using the RF signal generated from the oscillation unit; and
a narrow bandpass filter for receiving an RF-modulated signal from the mixer, and passing only a signal of the frequency band of the predetermined channel among the RF-modulated signal.

2. The RF modulator according to claim 1, wherein the oscillation unit includes:
an oscillator for generating an oscillation signal of a predetermined frequency according to a control voltage;
a divider for dividing a frequency generated from the oscillator at a predetermined rate;
a phase detector for comparing a division signal generated from the divider with a phase of a predetermined frequency; and
a charge pump for providing the oscillator with the control voltage adjusted by a phase difference received from the phase detector.

3. The RF modulator according to claim 2, wherein the narrow bandpass filter includes:
a plurality of variable voltage capacitor diodes and a plurality of inductors which adapt the control voltage as a reverse bias voltage, such that a pass band of the narrow bandpass filter changes with a variation in oscillation frequency of the oscillator affected by the control voltage.

4. The RF modulator according to claim 1, wherein the narrow bandpass filter is either a dielectric filter having a fixed pass band or a SAW (Surface Acoustic Wave) filter.

5. A Radio Frequency (RF) modulator for modulating video and audio signals into RF signals corresponding to a frequency band of a predetermined channel, comprising:
an oscillation unit including an oscillator for generating an oscillation signal of a predetermined frequency according to a control voltage VT, a divider for dividing a frequency generated from the oscillator at a predetermined rate, a phase detector for comparing a division signal generated from the divider with a phase of a predetermined frequency, and a charge pump for providing the oscillator with the control voltage adjusted by a phase difference received from the phase detector;
a mixer for modulating the video and audio signals using an RF signal generated from the oscillation unit; and
a narrow bandpass filter including a plurality of variable voltage capacitor diodes and a plurality of inductors, which adapt the control voltage as a reverse bias voltage, such that a pass band of the narrow bandpass filter changes with a variation in oscillation frequency of the oscillation unit affected by the control voltage.
